(19) United States
(12) Patent Application Publication
(10) Pub. No.: US 2010/0186238 A1
(43) Pub. Date: Jul. 29, 2010

(54) Electric heated knife assembly

(76) Inventor: Men-Tzon Shih, Niaosong Township (TW)

Correspondence Address: Muncy, Geissler, Olds & Lowe, PLLC, 4000 Legato Road, Suite 310, FAIRFAX, VA, 22033, US

(21) Appl. No.: 11/902,520

(22) Filed: Sep. 21, 2007

(51) Int. Cl. B26D 7/10; B26B 5/00; B26B 27/00

(52) U.S. Cl. 30/140; 219/241; 30/340

(57) ABSTRACT

An electric heated knife assembly is disclosed. The electric heated knife assembly includes an electric heated knife and a corresponding stand while the electric heated knife consists of a metal blade with high resistance, a blade holding part, a handle and a rechargeable battery inside the handle. A switch and two contacting points for charging are arranged on front end of the handle. The stand is for setting and storage of the electric heated knife and is connected to an external power source by a wire with a plug. Two electrically conductive contacts corresponding to two contact points for charging on front end of the handle are set on surface with an insertion hole of the stand. Without being used, the electric heated knife is set on the stand and is charged according to users needs. When in use, press a switch on the handle so that the metal blade is heated by the power of the rechargeable battery. Thus the convenience of use of the electric heated knife is improved without restrictions of operation and cleaning of conventional electric heated knife.

### BACKGROUND OF THE INVENTION

The present invention relates to an electric heated knife assembly, especially to an electric heated knife assembly having an electric heated knife with a corresponding stand so that the electric heated knife is set on the stand for charging rechargeable battery therein. In usage, a metal blade of the electric heated knife is heated by pressing a switch on a handle of the knife.

For a smooth and flat cut of ice or frozen cake, cheese cakes or cakes with frosted layer, a common way is to use a heated knife. Before each time of cut, the blade of the knife needs to be heated. Generally, a container with certain height such as a bottle or a bowl is filled with hot water to the very top so that the water flows over the whole blade. Users soak the blade of the knife in hot water for heating and then a wiper is used to absorb water and clean the knife. By repeating the procedures, cake is cut into a plurality of slices. Sometimes cheese wire or dental floss may use to cut cakes. However, the above heating way is labor intensive and time consuming. Thus there is a need to provide a better solution. Refer to CN89202125.X, ZL 200320102294.6, ZL 200520115687.X, ZL 200520115695.4, TW74208021, and TW090215569, a plurality of designs of the knife is revealed. The electric heated knife basically consists of a power supplier for providing a heater energy, a heater for converting power into heat, a heat-conductive blade such as metal blade for receiving heat generated by the heater. The electric heated knife may have more components such as a switch for turning on/off the heater, or a safety device such as a power-off device. However, there is a space for improvement. Conventional electric heated knives have a wire or a socket for connecting to an external power source so that the knife is used within a certain area. The wire also restricts smooth operation of the electric heated knife and affects adjustment of cutting angle of the electric heated knife. After use, the knife needs to be cleaned. The wire also leads to inconvenience of washing. There is a space for improvement.

An electric heated knife basically consists of a power supplier for providing a heater energy, a heater for converting power into heat, a heat-conductive blade such as metal blade for receiving heat generated by the heater. The electric heated knife may have more components such as a switch for turning on/off the heater, or a safety device such as a power-off device. However, there is a space for improvement. Conventional electric heated knives have a wire or a socket for connecting to an external power source so that the knife is used within a certain area. The wire also restricts smooth operation of the electric heated knife and affects adjustment of cutting angle of the electric heated knife. After use, the knife needs to be cleaned. The wire also leads to inconvenience of washing. There is a space for improvement.

### SUMMARY OF THE INVENTION

Therefore it is a primary object of the present invention to provide an electric heated knife assembly that includes an electric heated knife and a corresponding stand. The electric heated knife is composed of a metal blade with high resistance, a blade holding part, a handle and a rechargeable battery inside the handle. A switch and two contacting points for charging are arranged on front end of the handle while the stand is connected to an external power source by a wire. Two electrically conductive contacts corresponding to two contact points for charging on front end of the handle are set on surface with an insertion hole of the slot. While not used, the electric heated knife is set on the stand and is charged according to users needs. When being used, press a switch on the handle so that the metal blade is heated by the power of the rechargeable battery. Thus flexible and convenient operation of the electric heated knife is achieved.

It is another object of the e present invention to provide an electric heated knife assembly that includes a metal blade, a blade holding part and a handle. The above components are all attachable and detachable with each other. Thus cleaning or replacement of the metal blade is more convenient. Thus the convenience of use of the electric heated knife is further enhanced.

It is a further object of the e present invention to provide an electric heated knife assembly that includes a blade holding part and a handle made from high impact thermal-plastics. The blade holding part is connected with the handle in completely sealed status so as to prevent liquid or moisture from entering into inner space of the handle for protecting electrical components such as a rechargeable battery, a switch or an IC chip. Thus the electric heated knife can be cleaned by a dish washer. Therefore, the convenience of use is improved.

### BRIEF DESCRIPTION OF THE DRAWINGS

FIG. 1 is a schematic drawing showing a side view of an electric heated knife and a corresponding stand of an embodiment according to the present invention;

FIG. 2 is a side view of the electric heated knife of embodiment in FIG. 1;

FIG. 3 is a side view of an assembly of the electric heated knife with the stand of embodiment in FIG. 1.

### DETAILED DESCRIPTION OF THE PREFERRED EMBODIMENT

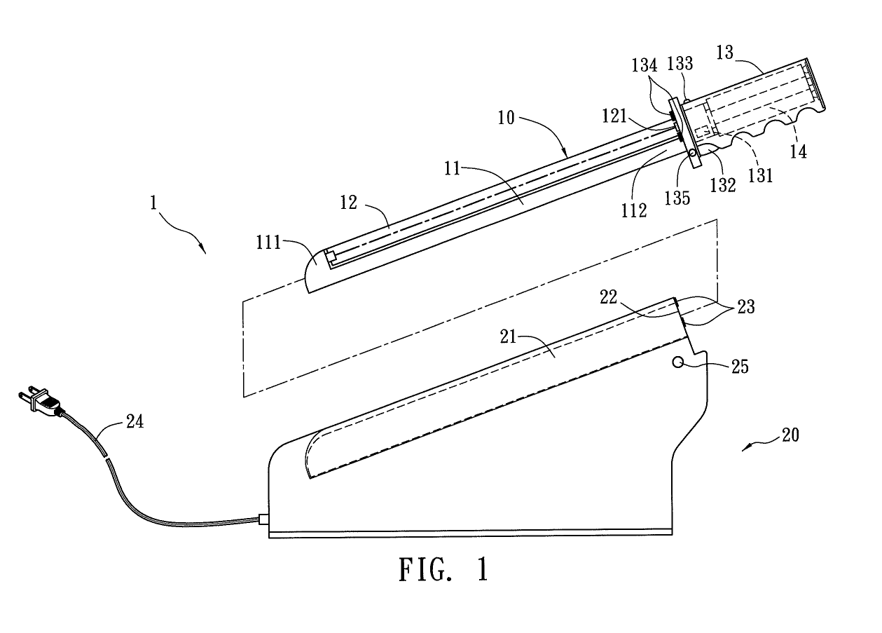

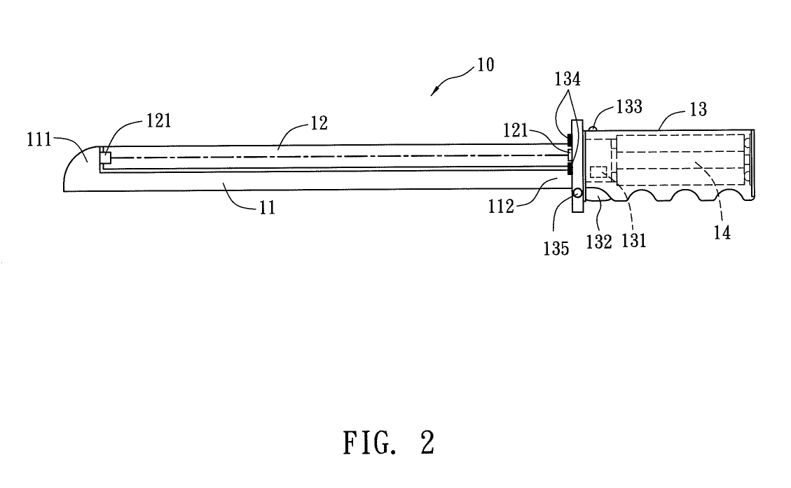

Refer from FIG. 1 to FIG. 3, an electric heated knife assembly 1 according to the present invention includes an electric heated knife 10 and a corresponding stand (cradle) 20. The electric heated knife 10 with length ranging from 10 to 12 inches consists of a metal blade 11 with high resistance, a blade holding part 12, a handle 13 and a rechargeable battery 14 inside the handle 13. The metal blade 11 is made from metals with high resistance such as 300 series stainless steel or steel with nickel plating because such metals have higher efficiency in converting power to heat.

The blade holding part 12 and the handle 13 are made from thermoplastics. The blade holding part 12 is sleeved on rear part of the metal blade 11 longitudinally. A positive conductive end and a negative conductive end 121 are disposed on front end and rear end of the blade holding part 12 respectively and are used to connect with positive electrode and negative electrode of the rechargeable battery 14. When the blade holding part 12 is assembled with the metal blade 11, the positive and negative conductive ends 121 are respectively connected with a front end 111 and a rear end 112 of the metal blade 11 so that current flows from the rechargeable battery 14 in the handle 13 through the metal blade 11. By electrical impedance of the front end 111 and the rear end 112 of the metal blade 11, the power is converted to heat that heats the metal blade 11. Thus the temperature of the metal blade 11 is elevated, Moreover, the temperature of the metal blade 11 can be regulated by disposition of a small IC thermostat 131 inside the handle 13 so as to prevent the metal blade 11 from overheating. The temperature ranges from 70˜80 Celsius degrees or 160˜175 Fahrenheit degrees.

A switch 132 is disposed on front end of the handle 13 so that users can press the switch for turning on/off power to provide current between the rechargeable battery 14 and the metal blade 11. That means to operate heating of the metal blade 11. A LED indicator light 133 is arranged on the handle 13 so as to display heated or unheated status mentioned above. Two contact points 134 for charging are disposed on front end of the handle 13.

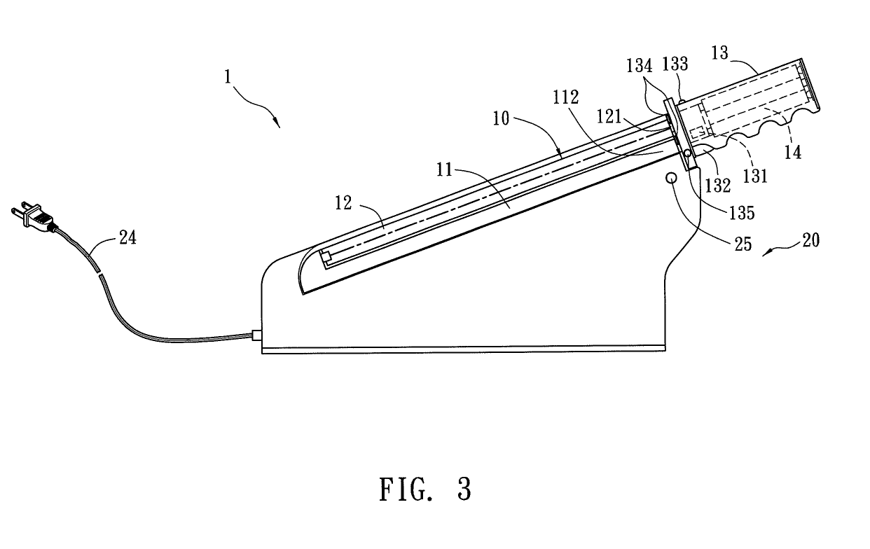

The stand 20 is a base with a slanting slot 21 corresponding to the metal blade 11 and the blade holding part 12 of the electric heated knife 10. Without being used, the electric heated knife 10 is inserted into the slot 21 for being set and storage. Now the electric heated knife 10 slants downwards while the handle 13 is exposed outside the slot 21 of the stand 20, as shown in FIG. 3. Moreover, two electrically conductive contacts 23 conducting power are set on surface having an insertion hole 22 of the slot 21 while the electrically conductive contacts 23 correspond to and contact with the two contact points 134 for charging on front end of the handle 13. By means of wires (with a plug) 24, the two electrically conductive contacts 23 connect with general indoor power supplies. After the two electrically conductive contacts 23 of the stand 20 contacting and connecting with two contact points 134 of the handle 13, the rechargeable battery 14 is charged by the power source. After the charging being completed (finished), the two electrically conductive contacts 23 of the stand 20 automatically cut off the power to prevent overcharging. Furthermore, a LED indicator light is installed on the electric heated knife 10 or the stand 20 for showing charging status.

The metal blade 11 and the blade holding 12 are attachable and detachable with each other. The same are the metal blade 11 and the handle 13. A blade release button 135 is arranged between the metal blade 11 and the handle 13 so that the metal blade 11 can be separated with the handle 13. This makes cleaning of the electric heated knife 10 or replacement of the metal blade 11 more convenient and easier.

Without being used, the electric heated knife 10 is inserted into the slot of the stand 20. The rechargeable battery 14 in the handle 13 of the electric heated knife 10 can be charged according to users needs. When being used, users can press the switch 132 on the handle 13 so as to heat the metal blade 11 by power from the rechargeable battery 14. Once the metal blade 11 is heated and the temperature is between 70˜80 Celsius degrees, it's easy to cut the frozen cakes, cheese cakes, chocolate cakes or cakes with frosted layer into slices with flat cutting edges. Moreover, without wires for connecting with external power sources on rear end of the electric heated knife 10, it's more convenient and flexible to operate the electric heated knife 10.

The blade holding part 12 and the handle 13 are made from high impact thermoplastics so they are rigid and durable. Moreover, they can be design into a completely sealed space so as to prevent liquid or moisture from entering into inner space of the handle 13 for protecting electrical components such as the rechargeable battery 14 or an IC thermostat 131. Furthermore, the switch 132 above the handle 13 is designed into moisture proof so that the electric heated knife can be washed by a dish washer. Thus the convenience of use is improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An electric heated knife assembly comprising an electric heated knife and a corresponding stand, wherein:
the electric heated knife having a metal blade, a blade holding part, a handle and a rechargeable battery inside the handle; the metal blade is made from metal with high resistance while the blade holding part disposed with a positive conductive end and a negative conductive end on front and rear end is sleeved on rear part of the metal blade longitudinally; the positive conductive end and the negative conductive end are respectively connected to positive electrode and negative electrode of the rechargeable battery; when the blade holding part is sleeved on the metal blade, the positive conductive end and the negative conductive end respectively connect to front end and rear end of the metal blade so that current flowing through the metal blade is converted to heat that elevates temperature of the metal blade; a switch is arranged on front end of the handle for control on/off status of current between the rechargeable battery and the metal blade as well as two contact points for charging;
the stand that is a base with a slot corresponding to the metal blade and the blade holding part of the electric heated knife; the electric heated knife is inserted into the slot while not in use; two electrically conductive contacts corresponding to two contact points for charging on front end of the handle are set on surface with an insertion hole of the slot; the two electrically conductive contacts are connected with general indoor power supplies so as to charge the rechargeable battery by connection between the two electrically conductive contacts of the stand and the two contact points for charging of the electric heated knife;
the electric heated knife is inserted into the slot of the stand and the rechargeable battery is charged by the indoor power supplies connected with the stand while not in use; when being used, the switch on the handle is pressed so as to heat the metal blade by the power of the rechargeable battery for smooth cutting.

2. The electric heated knife assembly as claimed in claim 1, wherein the metal blade is made from 300 series stainless steel or steel with nickel plating.

3. The electric heated knife assembly as claimed in claim 1, wherein a small IC thermostat is disposed in the handle for control temperature of the metal blade.

4. The electric heated knife assembly as claimed in claim 3, wherein temperature of the metal blade ranges from 70 to 80 Celsius degrees.

5. The electric heated knife assembly as claimed in claim 1, wherein a LED indicator light is arranged on the handle so as to show heating status of the metal blade.

6. The electric heated knife assembly as claimed in claim 1, wherein power of the two electrically conductive contacts of the stand are automatically turned off when charging of the rechargeable battery in the handle is finished.

7. The electric heated knife assembly as claimed in claim 1, wherein a LED is disposed on the stand or the electric heated knife for display charging status of the stand towards the electric heated knife.

8. The electric heated knife assembly as claimed in claim 1, wherein the metal blade and the blade holding are attachable and detachable with each other; the metal blade and the handle are attachable and detachable with each other; a blade release button is arranged between the metal blade and the handle so that the metal blade can be separated with the handle.

9. The electric heated knife assembly as claimed in claim 1, wherein the handle is a sealed space so as to prevent liquid or moisture from entering inner space of the handle.
